(19) United States
(12) Patent Application Publication
(10) Pub. No.: US 2012/0111373 A1
(43) Pub. Date: May 10, 2012

(54) SUBSTRATE CLEANING METHOD, SUBSTRATE CLEANING APPARATUS AND STORAGE MEDIUM FOR SUBSTRATE CLEANING

(75) Inventors: Hiroshi ARIMA, Koshi City (JP); Yuichi YOSHIDA, Koshi City (JP); Kousuke YOSHIHARA, Koshi City (JP)

(73) Assignee: TOKYO ELECTRON LIMITED, Tokyo (JP)

(21) Appl. No.: 13/288,255

(22) Filed: Nov. 3, 2011

(30) Foreign Application Priority Data
Nov. 4, 2010 (JP) 2010-247329
Sep. 8, 2011 (JP) 2011-196376

(51) Int. Cl. B08B 7/00; B08B 5/00; B08B 3/04

(52) U.S. Cl. 134/30; 134/99.1; 134/58 R

(57) ABSTRACT

A method for cleaning a surface of a substrate having a circuit pattern formed thereon, includes: forming a liquid film on the surface by feeding a cleaning solution onto the center of the surface while rotating the substrate with the substrate kept horizontal; forming a dry region by discharging gas to the center while moving a position of feed of the cleaning solution on the surface by a distance from the center toward the periphery of the substrate with the substrate being rotated; moving the position of feed of the cleaning solution on the surface toward the periphery at a speed equal to a speed at which the dry region is expanded toward the periphery while rotating the substrate; and controlling temperature of the cleaning solution to form the liquid film such that the temperature becomes higher than process atmosphere temperature on the surface during feed of the cleaning solution.

### CROSS-REFERENCE TO RELATED APPLICATIONS

This application claims the benefit of Japanese Patent Application Nos. 2010-247329 and 2011-196376 filed on Nov. 4, 2010 and Sep. 8, 2011, respectively, in the Japan Patent Office, the disclosures of which are incorporated herein in their entirety by reference.

### TECHNICAL FIELD

The present disclosure relates to a substrate cleaning method for cleaning a substrate having a circuit pattern formed thereon using a cleaning solution fed onto the substrate, a substrate cleaning apparatus using the same method, and a storage medium for substrate cleaning.

### BACKGROUND

In a semiconductor manufacturing process, a circuit pattern is formed by coating a photoresist on a substrate such as, for example, a semiconductor wafer or the like and exposing and developing a resist film according to a predetermined circuit pattern, is the process being called “photolithography process.” Typically, a photolithography process uses a processing system where a coating/developing apparatus is connected to an exposing apparatus.

In this photolithography process, a circuit pattern is formed by coating a developer on the substrate and dissolving a soluble portion of the resist. Thereafter, a cleaning process is generally carried out to remove a dissolved product of the resist and the developer from the substrate.

In the conventional art, as one example of the cleaning method, there has been known a spin cleaning method in which a cleaning solution is fed onto the center of a substrate, the substrate is rotated around a vertical axis to spread a liquid film of the cleaning solution by virtue of a centrifugal force caused by the rotation, and a dissolved product and a developer are removed from the substrate with them being taken on a liquid stream of the cleaning solution.

As another example of the cleaning method, there has been known a substrate cleaning method and apparatus in which a substrate is rotated around a vertical axis with the substrate kept horizontal, a cleaning solution is discharged to the center of the substrate and is spread over the entire surface of the substrate by virtue of a centrifugal force, a dry region is formed by discharging gas to the center of the substrate, and the substrate is cleaned by moving a cleaning solution nozzle outward and expanding the dry region toward the periphery of the substrate.

However, the conventional spin cleaning method has a poor effect from the removal of dissolved products, which requires a long spin cleaning process. In addition, recent use of high hydrophobic resist material makes it difficult to sufficiently remove dissolved products between circuit patterns even with the conventional long spin cleaning process. That is, when a high hydrophobic resist material is used, in cleaning after development, a liquid film of a cleaning solution is moved toward the periphery of the substrate quickly by virtue of a centrifugal force caused by the rotation of the substrate. Therefore, the dissolved products between the circuit patterns cannot be sufficiently removed with the cleaning solution, and, when the feeding of the cleaning solution is stopped, as shown in FIG. 11A, liquid scattering of the cleaning solution R occurs in the periphery of the substrate (wafer W) having a large centrifugal force, thereby keeping the dissolved products and cleaning solution R remaining between the circuit patterns, which result in development defects.

On the other hand, in the conventional art, the cleaning solution is fed onto the center of the substrate, the dry region is formed by discharging gas to the center of the substrate, and the cleaning solution nozzle is moved at a speed lower than a speed at which the dry region is expanded outward in order to prevent the liquid scattering. This substrate cleaning method may obtain a great cleaning effect for cleaning of a substrate having a high hydrophobic material coated thereon. However, even with such a technique, there is a need to sufficiently slow the cleaning solution nozzle in order to obtain a good cleaning effect. However, if the cleaning solution nozzle is slowed, time required for movement of the nozzle takes most of the process time, and thus there is a desire to increase the moving speed of the cleaning solution nozzle for improvement of throughput.

### SUMMARY

According to one embodiment of the present disclosure, there is provided a method for cleaning a surface of a substrate having a circuit pattern formed thereon, including the steps of: forming a liquid film on the entire surface of the substrate by feeding a cleaning solution onto the center of the surface of the substrate while rotating the substrate around the central axis of the substrate with the substrate kept horizontal; forming a dry region by discharging gas to the center of the substrate while moving a position of the feed of the cleaning solution on the surface of the substrate by a predetermined distance from the center of the substrate toward the periphery of the substrate with the substrate being rotated; moving the position of the feed of the cleaning solution on the surface of the substrate toward the periphery of the substrate at a speed substantially equal to a speed at which the dry region is expanded toward the periphery of the substrate while rotating the substrate; and controlling a temperature of the cleaning solution to form the liquid film such that the temperature of the cleaning solution becomes higher than process atmosphere temperature on the surface of the substrate at least during the feed of the cleaning solution.

According to another embodiment of the present disclosure, there is provided an apparatus for cleaning a surface of a substrate having a circuit pattern formed thereon, including: a substrate holder which holds the substrate horizontally such that the center of the substrate coincides with the central axis of rotation of the substrate; a rotation mechanism which rotates the substrate holder around the rotation central axis; a cleaning solution nozzle which feeds a cleaning solution onto the surface of the substrate held by the substrate holder; a gas nozzle which discharges gas to the surface of the substrate held by the substrate holder; a nozzle driving mechanism which moves the cleaning solution nozzle and the gas nozzle; a temperature regulator which controls a temperature of the cleaning solution such that the temperature of the cleaning solution becomes higher than process atmosphere temperature on the surface of the substrate at least during feed of the cleaning solution; and a controller which controls the rotation mechanism, a feeding part of the cleaning solution nozzle, a feeding part of the gas nozzle, the nozzle driving mechanism and the temperature regulator, wherein, based on a control signal from the controller, a liquid film is formed on the entire surface of the substrate by feeding the cleaning solution from the cleaning solution nozzle onto the center of the surface of the substrate while rotating the substrate, a dry region is formed by discharging gas from the gas nozzle to the center of the substrate while moving the cleaning solution nozzle by a predetermined distance from above the center of the substrate toward the periphery of the substrate, and the cleaning solution nozzle is moved toward the periphery of the substrate at a speed substantially equal to a speed at which the dry region is expanded toward the periphery of the substrate.

According to another embodiment of the present disclosure, there is provided an apparatus for cleaning a surface of a substrate having a circuit pattern formed thereon, including: a substrate holder which holds the substrate horizontally such that the center of the substrate coincides with the central axis of rotation of the substrate; a rotation mechanism which rotates the substrate holder around the rotation central axis; a cleaning solution nozzle which feeds a cleaning solution onto the surface of the substrate held by the substrate holder; a gas nozzle which discharges gas to the surface of the substrate held by the substrate holder; a nozzle driving mechanism which moves the cleaning solution nozzle and the gas nozzle together, with the cleaning solution nozzle separated by a predetermined gap from the gas nozzle; a temperature regulator which controls a temperature of the cleaning solution such that the temperature of the cleaning solution becomes higher than process atmosphere temperature on the surface of the substrate at least during feed of the cleaning solution; and a controller which controls the rotation mechanism, a feeding part of the cleaning solution nozzle, a feeding part of the gas nozzle, the nozzle driving mechanism and the temperature regulator, wherein, based on a control signal from the controller, a liquid film is formed on the entire surface of the substrate by feeding the cleaning solution from the cleaning solution nozzle onto the center of the surface of the substrate while rotating the substrate, a dry region is formed by arranging the gas nozzle above the center of the substrate and discharging gas from the gas nozzle to the center of the substrate while moving the cleaning solution nozzle from above the center of the substrate toward the periphery of the substrate, the cleaning solution nozzle and the gas nozzle are moved together toward the periphery of the substrate at a speed substantially equal to a speed at which the dry region is expanded toward the periphery of the substrate, and the feeding of the cleaning solution and the discharging of the gas are stopped when the cleaning solution nozzle reaches above the periphery of the substrate.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a schematic plan view showing the entire processing system in which an exposing apparatus is connected to a coating/developing apparatus and to which a substrate cleaning apparatus according to the present disclosure is applied.

FIG. 2 is a schematic perspective view of the processing system.

FIG. 3 is a schematic longitudinal sectional view of a developing apparatus to which a substrate cleaning apparatus according to a first embodiment of the present disclosure is applied.

FIG. 4 is a plan view showing the substrate cleaning apparatus according to the first embodiment.

FIG. 5A to 5E are explanatory views showing a substrate cleaning method using the substrate cleaning apparatus according to the first embodiment.

FIGS. 6A and 6B are explanatory views showing a cleaning mechanism when a substrate is cleaned using the substrate cleaning method of the present disclosure.

FIG. 7A to 7D are explanatory views showing a substrate cleaning method according to a second embodiment of the present disclosure.

FIG. 8 is a schematic longitudinal sectional view of a developing apparatus to which a substrate cleaning apparatus according to a third embodiment of the present disclosure is applied.

FIG. 9 is a schematic longitudinal sectional view of a developing apparatus to which a substrate cleaning apparatus according to a fourth embodiment of the present disclosure is applied.

FIG. 10 is a schematic longitudinal sectional view of a developing apparatus to which a substrate cleaning apparatus according to a fifth embodiment of the present disclosure is applied.

FIG. 11A is a plan view of a wafer having radial defects and FIG. 11B is a plan view of a wafer having concentric defects.

FIG. 12 is an explanatory view showing liquid scattering of a cleaning solution between circuit patterns.

FIG. 13A is a graph showing linear speeds at different points on a wafer for different speeds of rotations of the wafer.

FIG. 13B is a graph showing the speed of rotation controlled at different points on a wafer for different maximum speeds of rotation at which no mist occurs in the periphery of the wafer.

FIG. 14 is a graph showing results of an evaluation test.

### DETAILED DESCRIPTION

Embodiments of the present disclosure will now be described in detail with reference to the accompanying drawings. Here, a case where a substrate cleaning apparatus according to the present disclosure is applied to a processing system in which an exposing apparatus is connected to a coating/developing apparatus will be illustrated.

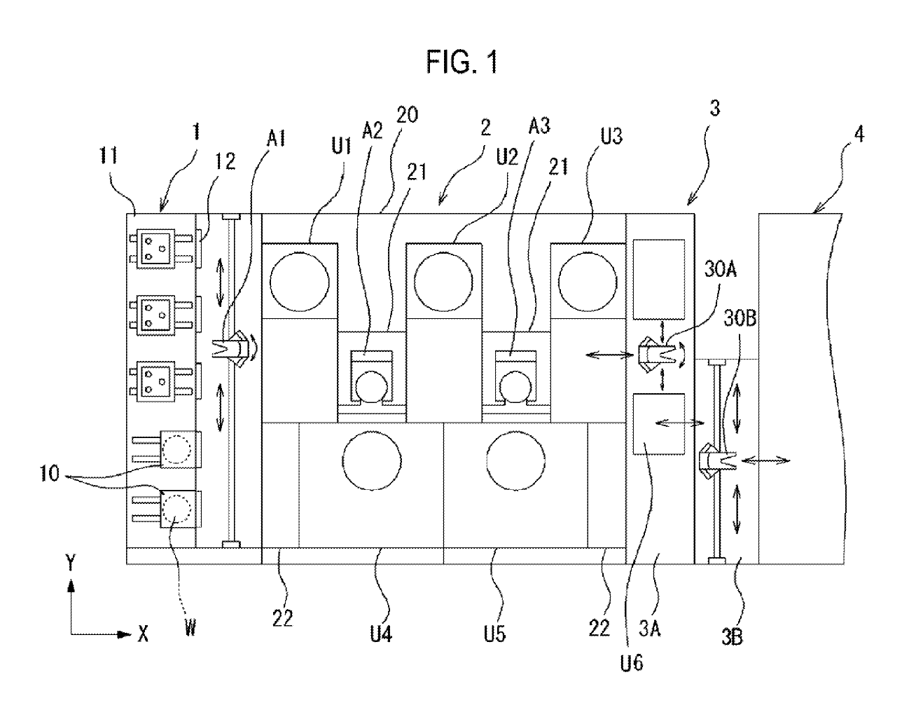

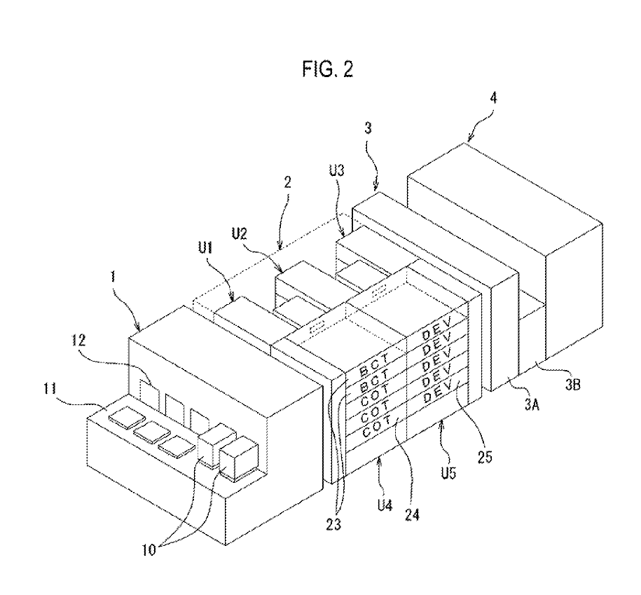

Referring to FIGS. 1 and 2, the processing system includes a carrier station 1 which carries in/out carriers 10 which air-tightly receive a plurality of (for example 25) semiconductor wafers W (hereinafter abbreviated as “wafers W”) which are substrates to be processed, a processing section 2 which performs various processes, such as resist coating, developing and so on, for wafers W taken out of the carrier station 1, an exposing section 4 which subjects the surfaces of the wafers W to liquid immersion lithography with transparent liquid layers formed on the surfaces of the wafers W, and an interface section 3 which is connected between the processing section 2 and the exposing section 4 for delivering the wafers W.

The carrier station 1 is provided with a loader 11 on which the plurality of carriers 10 may be loaded, a shutter 12 which is formed in the front wall when viewed from the loader 11, and a delivery means A1 which takes the wafers W out of the carriers 10 via the shutter 12.

The processing section 2 is surrounded by a housing 20 and is connected to an inner side of the carrier station 1. The processing section 2 includes shelf units U1, U2 and U3, which are multi-staged units of a heating/cooling system and arranged in the left front side and liquid processing units U4 and U5 arranged in the right front side when viewed from the carrier station 1. Main carrying means A2 and A3 for delivering the wafers W between the shelf units U1, U2 and U3 are alternately arranged between the shelf units U1, U2 and U3. In addition, the main carrying means A2 and A3 are disposed within a space surrounded by one side of the shelf units U1, U2 and U3 disposed forward and backward when viewed from the carrier station 1, one side of the liquid processing units U4 and U5 disposed at the right side of the processing section 2 when viewed from the carrier station 1, which will be described later, and a partition wall 21 disposed at the left side of the processing section 2 when viewed from the carrier station 1 to form a back side. In addition, temperature/humidity regulating units 22, each including a thermostat of a process liquid used in each unit, a temperature/humidity regulating duct, etc., are disposed between the carrier station 1 and the processing section 2 and between the processing section 2 and the interface section 3, respectively.

The interface unit 3 includes a first carrying chamber 3A and a second carrying chamber 3B interposed back and forth between the processing section 2 and the exposing section 4. The first carrying chamber 3A is provided with a first wafer carrying part 30A, and the second carrying chamber 3B is provided with a second wafer carrying part 30B. Each of the shelf units U1, U2 and U3 is constituted by a plurality of (for example, 10) stacked units for performing a pre-process and a post-process of a process performed in the liquid processing units U4 and U5, a combination of which includes a heating unit (HP) for heating (or baking) a wafer W, a cooling unit (CPL) for cooling a wafer W, etc. Each of the liquid processing units U4 and U5 is constituted by a plurality of (for example, 5) stacked units including a bottom anti-reflection film coating unit (BCT) 23 for coating an anti-reflection film on a portion of the wafer W for receiving chemicals such as resist, developer, or the like, a coating unit (COT) 24, or a developing unit (DEV) 25 for feeding a developer onto a wafer W for development, etc., as shown in FIG. 2. The substrate cleaning apparatus of the present disclosure is contained in the developing unit (DEV) 25.

Next, a flow of a wafer W in the above-described processing system will be described in brief First, when carriers 10 accommodating wafers W are loaded on the loader 11, the covers of the carriers 10 are taken off, along with the shutter 12, and a wafer W is taken out by the delivery means A1. Then, the wafer W is delivered to the main carrying means A2 via a delivery unit constituting one stage of the shelf unit U1 and, as a pre-process of a coating process, hydrophobic treatment or substrate temperature adjustment is performed in a shelf of one of the shelf units U1 to U3.

Thereafter, the wafer W is carried into the coating unit (COT) 24 by the main carrying means A2 and a resist film is formed on the wafer W. The wafer W with the resist film is carried out by the main carrying means A2 and is carried into a heating unit where a bake process is performed for the wafer W at a predetermined temperature. The baked wafer W is cooled in a cooling unit, is carried into the interface section 3 via a delivery unit of the shelf unit U3, and then is carried into the exposing section 4 via the interface section 3. If a protection film for liquid immersion lithography is to be coated on the resist film, after the wafer W is cooled in the cooling unit, chemicals for the protection film are coated on the wafer W in a unit (not shown) in the processing section 2. Thereafter, the wafer W is carried into the exposing section 4 where the wafer W is subjected to the liquid immersion lithography. At this time, the wafer W may be cleaned in a substrate cleaning apparatus (not shown) of the present disclosure provided in the interface section 3 before the liquid immersion lithography.

The wafer W subjected to the liquid immersion lithography is taken out of the exposing section 4 by means of the second wafer carrying part 30B and is carried into a heating unit (PEB) constituting one stage of the shelf unit U6. Thereafter, the wafer W is carried from the heating unit PEB by means of the first wafer carrying part 30A and is delivered to the main carrying means A3. Then, the wafer W is carried into the developing unit 25 by means of the main carrying means A3. In the developing unit 25, the wafer W is developed and cleaned by means of the substrate cleaning apparatus of the present disclosure which is also used for development. Thereafter, the wafer W is carried from the developing unit 25 by means of the main carrying means A3 and is returned to the original carrier 10 on the loader 11 via the main carrying means A2 and the delivery means A1.

### First Embodiment

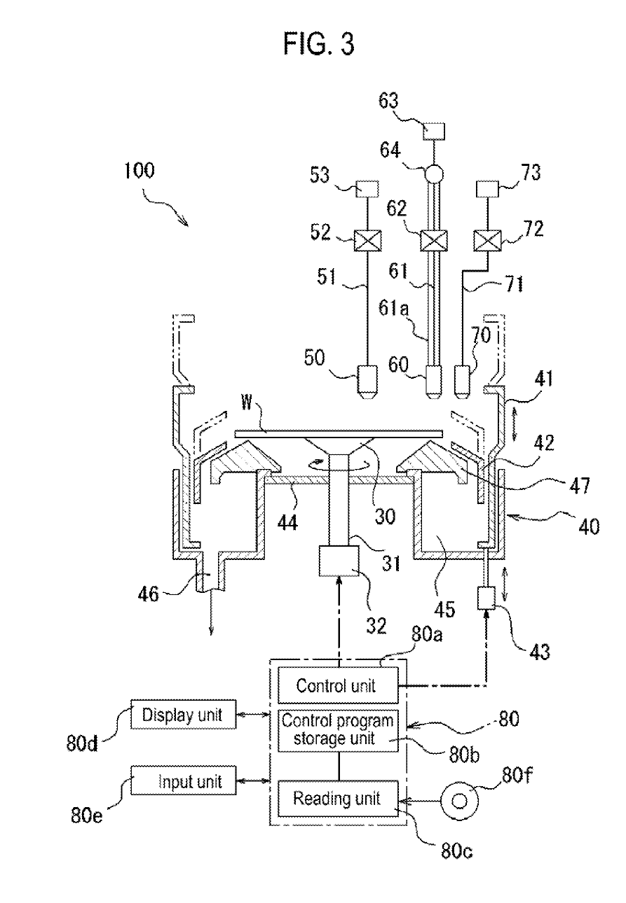

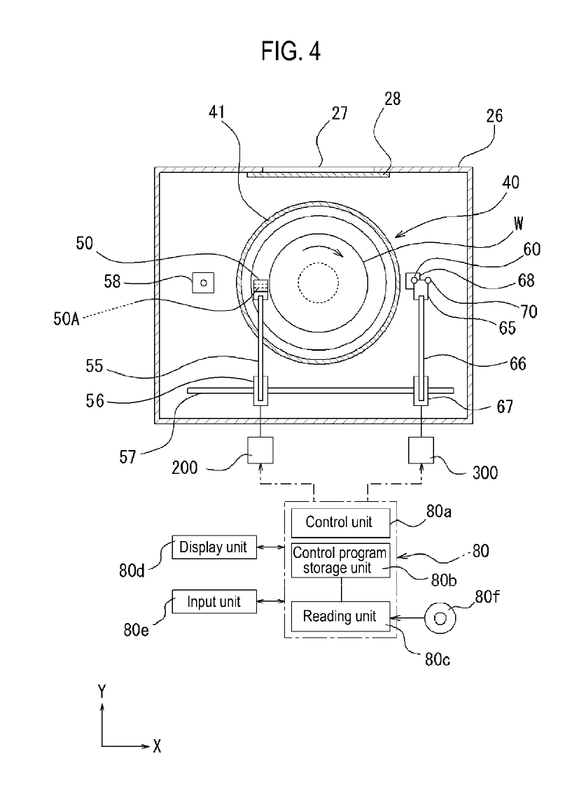

An embodiment where the substrate cleaning apparatus of the present disclosure is combined to a developing apparatus will be described with reference to FIGS. 3 and 4.

As shown in FIGS. 3 and 4, the substrate cleaning apparatus 100 includes spin chuck 30, which is a substrate holder for absorbing the central portion of the back side of the wafer W and keeping the wafer W horizontal, in a casing 26. The spin chuck 30 is connected to a rotation mechanism 32 such as, for example, a servo motor or the like, via a shaft 31 and is configured to be rotated by the rotation mechanism 32 with the wafer W held by the spin chuck 30. The rotation mechanism 32 is electrically connected to a control unit 80a of a control computer 80 as a control means and the speed of rotation of the spin chuck 30 is controlled based on a control signal from the control computer 80. An inlet/outlet 27 for the wafer W is formed in the casing 26 and an openable/closable shutter 28 is arranged in the inlet/outlet 27.

A cup body 40 with its top opened is provided to surround the lateral side of the wafer W on the spin chuck 30. The cup body 40 includes a cylindrical outer cup 41 and a tubular inner cup 42 with its upper portion inclined inwardly. The outer cup 41 is elevated by means of an elevating mechanism 43 such as, for example, a cylinder, connected to the bottom of the outer cup 41, and the inner cup 42 can be elevated as it is pushed up to a step formed in the inner circumference at the bottom of the outer cup 41. The elevating mechanism 43 is electrically connected to the control computer 80 and the outer cup 41 is elevated based on a control signal from the control computer 80.

A circular plate 44 is disposed below the spin chuck 30 and a liquid receiving part 45 having a concave section is disposed over the entire circumference of the outside of the circular plate 44. A drain outlet 46 is formed in the bottom of the liquid receiving part 45. A developer and a cleaning solution overflowing and dropping from the wafer W or cast out of the wafer W and collected in the liquid receiving part 45 are discharged out of the apparatus via the drain outlet 46. A ring member 47 having a mountain-like section is provided at the outside of the circular plate 44. A plurality of (for example, 3) elevating pins (not shown) which are substrate supporting pins penetrating through the circular plate 44 are also provided in the outside of the circular plate 44. The wafer W is delivered to the spin chuck 30 in cooperation between the elevating pins and a substrate carrying means (not shown).

A developer nozzle 50, a cleaning solution nozzle 60 and a gas nozzle 70, all of which can be elevated and horizontally moved, are provided above the wafer W held by the spin chuck 30. The developer nozzle 50 has a slit-like discharging hole 50A for feeding a band-like developer to the wafer W held by the spin chuck 30. The discharging hole 50A is longitudinally arranged along the diameter direction of the wafer W. The developer nozzle 50 is connected to a source of developer 53 via a developer feeding pipe 51 with a flow rate regulator 52, such as, for example, a flow control valve or the like, interposed therebetween. Flow rate and feed time of developer are controlled by the flow rate regulator 52.

The developer nozzle 50 is supported at one end of a nozzle arm 55 which is a supporting member. The other end of the nozzle arm 55 is connected to a moving base 56 having an elevating mechanism (not shown). The moving base 56 can be horizontally moved by a nozzle moving mechanism 200, such as, for example, a ball screw mechanism or a timing belt mechanism, along a guide member 57 extending in an X direction in the bottom of the casing 26. In the outside of one side of the cup body 40 is provided a standby part 58 of the developer nozzle 50 in which an operation including a nozzle leading end cleaning is performed.

Above the spin chuck 30 is provided the cleaning solution nozzle 60 which is connected to a source of cleaning solution 63 via a cleaning solution feeding pipe 61 with a flow rate regulator 62 interposed therebetween. Flow rate and feed time of cleaning solution are controlled by the flow rate regulator 62 such as, for example, a flow control valve or the like.

A temperature regulator 64 equipped with a heating device, such as, for example, a heater or the like, is connected to the cleaning solution source 63. The temperature regulator 64 adjusts the cleaning solution to a desired temperature. The cleaning solution feeding pipe 61 including the flow rate regulator 62 is surrounded by a temperature maintaining member 61a such as an insulating member or the like. Thus, the cleaning solution can be maintained at a desired temperature controlled by the temperature regulator 64 until the cleaning solution is fed from the cleaning solution nozzle 60 onto the wafer W.

As shown in FIG. 4, the cleaning solution nozzle 60 is fixed to a nozzle arm 66 via a nozzle holder 65 and the nozzle arm 66 is connected to a moving base 67 having an elevating mechanism (not shown). The moving base 67 can be horizontally moved by a nozzle moving mechanism 300, such as, for example, a ball screw mechanism or a timing belt mechanism, along the guide member 57 without interference with the developer nozzle 50. In the outside of the other side of the cup body from the standby part 58 of the developer nozzle 50 is provided a standby part 68 of the cleaning solution nozzle 60.

The gas nozzle 70 is connected to a source of gas 73 via a gas feeding pipe 71 with a gas flow rate regulator 72 interposed therebetween. In this embodiment, inert gas such as nitrogen (N₂) or the like is used as gas discharged from the gas nozzle 70. The gas nozzle 70 is fixed to the nozzle holder 65, along with the cleaning solution nozzle 60, and is moved, with it integrated with the cleaning solution nozzle 60, by means of the nozzle arm 66.

The nozzle moving mechanism 200 for moving the developer nozzle 50, the nozzle moving mechanism 300 for moving the cleaning solution nozzle 60 and the gas nozzle 70, the rotating mechanism 32 for rotating the spin chuck 30, the elevating mechanism 43 of the cup body 40, and the flow rate regulators 52, 62 and 72 for controlling flow rates of the developer, cleaning solution and gas are controlled by the control unit 80a. The control unit 80a is contained in the control computer 80 which also contains a control program storage unit 80b for storing a program to execute various processes in an operation performed by the substrate cleaning apparatus 100, as will be described later, and a reading unit 80c. The control computer 80 may further include an input unit 80e connected to the control unit 80a, a display unit 80d for displaying a treatment process screen used to prepare a treatment process, and a computer readable storage medium 80f which is loaded into the reading unit 80c and stores software to cause the control computer 80 to execute a control program. The control computer 80 is configured to output control signals to various components or units based on the control program.

The control program may be installed in the control computer 80 from the storage medium 80f such as, for example, a hard disk, a compact disk, a flash memory, a flexible disk, a memory card or the like.

Next, an operation of the above-configured substrate cleaning apparatus 100 will be described. First, when no wafer W is carried into the substrate cleaning apparatus 100, the outer cup 41 and the inner cup 42 are in decent position. The developer nozzle 50, the cleaning solution nozzle 60 and the gas nozzle 70 wait at their respective standby positions. In the above processing system, when a wafer W subjected to liquid immersion lithography is heated and then carried into the substrate cleaning apparatus 100 by the main carrying means A3 (see FIG. 1), the wafer W is delivered to the spin chuck 30 in cooperation between the main carrying means A3 and elevating pins (not shown). In this embodiment, resist material having high hydrophobicity is used and a static contact angle of water on a surface of the wafer W carried into the substrate cleaning apparatus 100 is, for example, 90°.

Thereafter, while the outer cup 41 and the inner cup 42 are set to be in ascent position, a developer is fed from the developer nozzle 50 onto the wafer W in a known manner. In this embodiment, at the start of the feed of developer, the developer nozzle 50 is arranged above the periphery of the wafer W, for example, apart by several mm from the surface of the wafer W. The developer nozzle 50 is moved from the periphery to the center of the wafer W while rotating the wafer W with the speed of rotation of, for example, 1000 to 1200 rpm and discharging the developer in the form of a band from the developer nozzle 50. The developer discharged in the form of a band from the developer nozzle 50 is successively arranged from the outside to the inside of the wafer W, which results in spiral feed of developer over the entire surface of the wafer W. Then, the developer is spread outwardly along the surface of the wafer W by virtue of a centrifugal force caused by rotation of the wafer W, thereby forming a thin liquid film. Thus, a soluble portion of resist is dissolved by the developer, leaving an insoluble portion to form a circuit pattern.

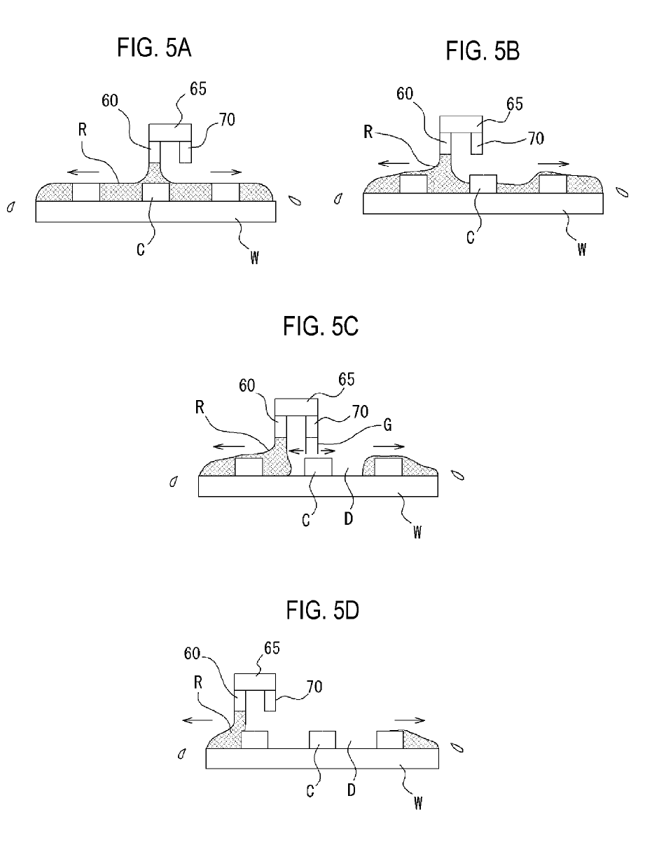

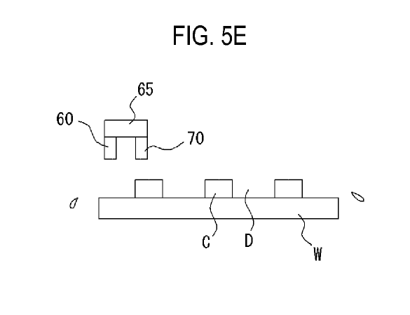

Next, the developer nozzle 50 is exchanged with the cleaning solution nozzle 60 which is then arranged above the center of the wafer W. Immediately after the developer nozzle 50 stops the feeding of the developer, a cleaning solution R is quickly discharged from the cleaning solution nozzle 60 to clean the surface of the wafer W. Hereinafter, the cleaning process will be described in more detail with reference to FIGS. 5A to 6B.

The cleaning process of this embodiment is performed according to the following steps.

(Step 1) As shown in FIG. 5A, the cleaning solution nozzle 60 is arranged over the center C of the wafer W, for example, apart by 15 mm from the surface of the wafer W. While rotating the spin chuck 30 with the speed of rotation of, for example, 1000 rpm, the cleaning solution R such as, for example, pure water, is discharged from the cleaning solution nozzle 60 to the center C of the wafer W at a flow rate of 250 ml/min for 5 seconds, for example. The cleaning solution R is spread from the center C toward the periphery of the wafer W by virtue of a centrifugal force, which results in substitution of the developer with the cleaning solution R. Thus, a liquid film of the cleaning solution R is formed on the entire surface of the wafer W.

The cleaning solution R is beforehand adjusted to a temperature range of 23 degrees Celsius to 50 degrees Celsius, for example, 30 degrees Celsius. Accordingly, the temperature of the cleaning solution R fed onto the center C of the wafer W is set to a temperature, for example, about 30 degrees Celsius, higher than 23 degrees Celsius which is an atmosphere temperature of the substrate cleaning apparatus 100. The reason why the upper limit of the temperature range is set to 50 degrees Celsius is that more than 50 degrees Celsius may make it difficult to control an atmosphere of a coating/developing apparatus.

(Step 2) As shown in FIG. 5B, by moving the nozzle arm 66 (see FIG. 4) while rotating the spin chuck 30 with the speed of rotation of more than 1500 rpm, for example, 2000 rpm, the cleaning solution nozzle 60 is moved by a predetermined distance from the center C toward the periphery of the wafer W, so that the gas nozzle 70 is arranged above the center C of the wafer W. At this time, the cleaning solution nozzle 60 is moved at a rate of, for example, 150 mm/sec while discharging the cleaning solution R with a flow rate of, for example, 250 ml/min. Here, when the cleaning solution nozzle is moved by a certain distance outward from the center C of the wafer W, the cleaning solution R is not fed onto the center C. However, as shown in FIG. 5B, since the center C has a small centrifugal force, a thin liquid film of the cleaning solution R is maintained without being broken.

When the gas nozzle 70 is moved above the center C of the wafer W, the nozzle arm 66 is stopped and, for example, N₂ gas G is sprayed from the gas nozzle 70 onto the center C of the wafer W. As shown in FIG. 5C, when the N₂ gas is sprayed from the gas nozzle 70, the thin liquid film maintained in the center C is broken and, accordingly, a core of a dry region D appears. Here, the dry region D refers to a region where the surface of the wafer W is exposed as the cleaning solution R is evaporated, including attachments of microscopic droplets to the surface of the wafer W. The core of the dry region D expands from the center C toward a position of the feed of the cleaning solution R by virtue of a centrifugal force. In this embodiment, a period of time from the start of discharging of the N₂ gas G to the stop of the discharging is, for example, 5 seconds. Thus, a circular dry region D having its radius corresponding to a distance from the center C of the wafer W to the position of the feed of the cleaning solution R is completely dried.

In this embodiment, since the surface of the wafer W has a water contact angle of 90° and high hydrophobicity, a speed at which the dry region D expands outward by virtue of the centrifugal force caused by the rotation of the wafer W is considerably higher than that of a hydrophilic wafer W. However, since a centrifugal force by the rotation of the wafer W in the vicinity of the center C is small, the dry region D slowly expands toward a region of the feed of the cleaning solution R while eliminating a liquid film of the cleaning solution R. In Step 1, the feed of the cleaning solution R starts from the center C of the wafer W, the fed cleaning solution R collides with the center C, and a dissolved product in the center C is efficiently discharged outward by virtue to the collision and the centrifugal force caused by the rotation of the wafer W. Accordingly, a cleaning solution in a concave portion of a circuit pattern is reliably discharged to produce no defect.

In order to form a good dry region D, there is a need to arrange the cleaning solution nozzle 60 and the gas nozzle 70 with an appropriate distance therebetween. In this embodiment, this distance is about 9 mm to about 15 mm. If the distance is smaller than 9 mm, the dry region D is not formed well since a liquid film of the cleaning solution R is not sufficiently thin. If the distance is larger than 15 mm, a wide region is dried in an instant, which may result in more defects.

(Step 3) With the wafer W continuing to be rotated after forming the dry region D in Step 2, the cleaning solution nozzle 60 and the gas nozzle 70 are together moved to the periphery of the wafer W while feeding the cleaning solution R from the cleaning solution nozzle 60 onto the surface of the wafer W, as shown in FIG. 5D.

When the center of the cleaning solution nozzle 60 reaches a position slightly biased from the periphery toward the center of the wafer W, for example, a position apart by 2 to 10 mm from the periphery of the wafer W (FIG. 5E), the discharging of the cleaning solution R from the cleaning solution nozzle 60 is stopped. At this time, the discharging of gas from the gas nozzle 70 continues to be stopped. The wafer W continues to be rotated. If the cleaning solution R from the cleaning solution nozzle 60 is fed until it reaches the periphery of the wafer W, the cleaning solution R bounds from the periphery, particularly a notch, of the wafer W and returns, as mist, to the surface of the wafer W. Accordingly, it is preferable to stop the feed of the cleaning solution R before it reaches the periphery of the wafer W.

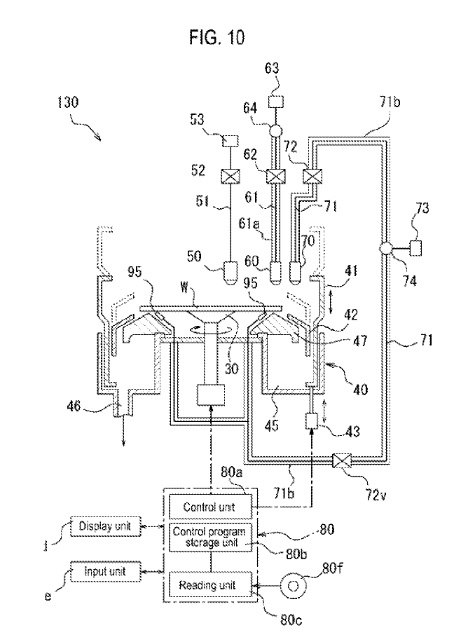

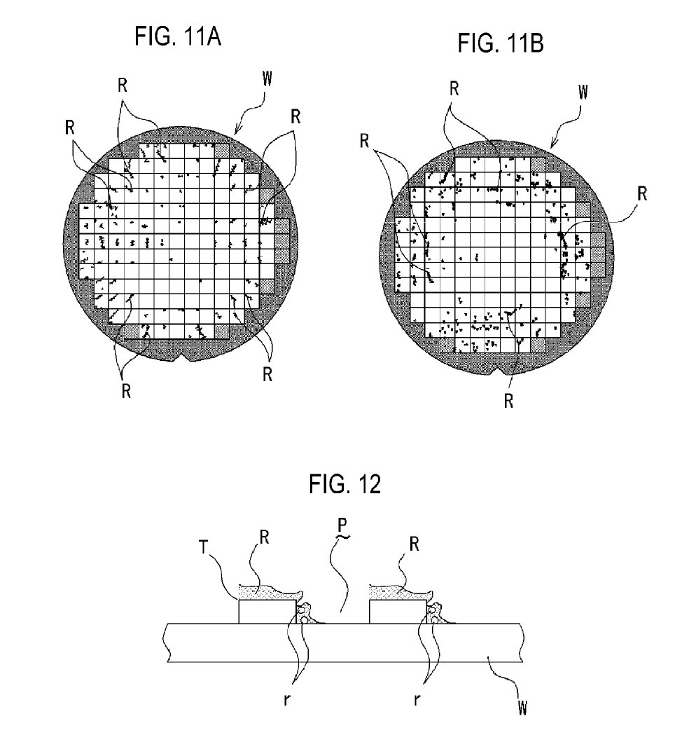

As described above, if the surface of the wafer W has high hydrophobicity, when the feeding of the cleaning solution R is stopped with the wafer W being rotated, liquid scattering occurs at the periphery of the wafer W having a large centrifugal force, which results in the radial defects shown in FIG. 11A. These radial defects occur when the cleaning solution R bursts between a convex top T and a concave portion P of a circuit pattern and the cleaning solution R and dissolved products r are left in the concave portion P, as shown in FIG. 12. In this embodiment, by moving the position of the feed of the cleaning solution R of the cleaning solution nozzle 60 while rotating the wafer W, the dissolved products r in the concave portion P of the circuit pattern are scraped out by an impact by the feeding of the cleaning solution R at all positions on the surface of the wafer W, as shown in FIGS. 6A and 6B, and are discharged by virtue of the centrifugal force caused by the rotation of the wafer W with the dissolved products r taken on a liquid stream of the cleaning solution R.

In this embodiment, a moving speed of the cleaning solution nozzle 60 is set to be approximately equal to a speed at which the dry region D expands toward the periphery of the wafer W. The moving speed is preferably in a range of about 5 mm/sec to about 20 mm/sec, about 10 mm/sec in this embodiment, although it depends on the speed of rotation of the wafer W. As used herein, the phrase “speed at which the dry region D expands toward the periphery of the wafer W” refers to a speed at which the dry region D expands outward when a liquid film is formed on the center C of the wafer W by feeding the cleaning solution R onto the center C while rotating the wafer W and then the N₂ gas G is sprayed thereon without feeding the cleaning solution R. As used herein, the phrase “approximately equal to a speed” includes a moving speed of the cleaning solution nozzle 60, which is slightly lower than the speed at which the dry region D expands toward the periphery of the wafer W. The reason why the moving speed of the cleaning solution nozzle 60 is set to be approximately equal to the speed at which the dry region D expands toward the periphery of the wafer W is that liquid scattering occurs if the moving speed of the cleaning solution nozzle 60 is higher than the expanding speed of the dry region D, which may result in impossibility of effective discharging dissolved products r and cleaning solution R by virtue of the centrifugal force caused by the rotation of the wafer W. On the other hand, if the moving speed of the cleaning solution nozzle 60 is excessively lower than the expanding speed of the dry region D, a liquid stream of the cleaning solution R to be spread outward is disturbed to prevent dissolved products r from being quickly discharged and the process time is protracted, which results in low throughput.

In Step 3, like Steps 1 and 2, the cleaning solution R is beforehand adjusted to a temperature, for example, about 30 degrees Celsius, higher than 23 degrees Celsius by means of the temperature regulator 64. Increase in the temperature of the cleaning solution R on the surface of the wafer W can provide a higher expansion speed of the dry region D toward the periphery of the wafer W. This may result in a higher moving speed of the cleaning solution nozzle 60 and hence a higher throughput, as shown in an evaluation test which will be described later. In this case, it is preferable that the temperature of the cleaning solution R is higher than 23 degrees Celsius, which is the atmosphere temperature of the module, and but is lower than 50 degrees Celsius in consideration of an effect on other modules in the apparatus.

In Step 3, the speed of rotation of the wafer W is controlled such that the centrifugal force caused by the rotation of the wafer W at each position of the feed of the cleaning solution R becomes constant in computation. That is, the speed of rotation of the wafer W may be controlled such that it becomes large as the position of the feed of the cleaning solution R approaches the center of the wafer W, whereas it becomes small as the feed position approaches the periphery of the wafer W. Such control of the speed of rotation uniformalizes an amount of fed cleaning solution R per unit area of the surface of the wafer W, thereby achieving a great cleaning effect even in a region in the outside of the center C of the wafer W.

It is preferable that the speed of rotation at the start of Step 3 is, for example, 500 rpm to 3000 rpm. If the speed of rotation of the wafer W is larger than 3000 rpm, mist occurs and is attached to the dry region D of the wafer W in a concentric manner, which may result in development defects as shown in FIG. 11B. If the speed of rotation of the wafer W is smaller than 500 rpm, the expansion speed of the dry region D becomes low protracting the process time. In this embodiment, the speed of rotation at the start of Step 3 is, for example, 2000 rpm. The moving speed of the cleaning nozzle 60 in Step 3 is preferably as high as possible in order to shorten the process time. However, in order to show a great cleaning effect, the moving speed is set to be approximately equal to the expansion speed of the dry region D toward the periphery of the wafer W, preferably about 5 mm/sec to about 20 mm/sec.

(Step 4) After the feed of the cleaning solution R from the cleaning solution nozzle 60 is stopped, the wafer W is rotated with the speed of rotation before the stop of the feed of the cleaning solution R, for example, 2000 rpm. This causes the dry region D to expand to the periphery of the wafer W. Thereafter, with the speed of rotation of the wafer W set to, for example, 2000 rpm, the wafer W is dried by casting microscopic droplets out of the wafer W using a centrifugal force. At the same time, the cleaning solution nozzle 60 and the gas nozzle 70 are returned to their respective standby positions.

A series of Step 1 to Step 4 is performed when the control computer 80 reads the control program stored in the memory of the control computer 80 and outputs a control signal to operate the above-described mechanisms based on the read control program.

According to the first embodiment, the wafer W coated with the high hydrophobic resist material is developed, the cleaning solution R is fed onto the center C of the wafer W, the position of the feed of the cleaning solution R is moved by a certain distance toward the periphery of the wafer W, gas is discharged from the gas nozzle 70 to the center C of the wafer W to generate the dry region D, and then, with the wafer W being rotated, the position of the feed of the cleaning solution R is moved toward the periphery of the wafer W at a speed which is approximately equal to the expansion speed of the dry region D toward the periphery of the wafer W. This configuration of the first embodiment can realize a great cleaning effect and achieve no or little development defect. In addition, in the first embodiment, by feeding the cleaning solution R beforehand adjusted to a temperature higher than 23 degrees Celsius by means of the temperature regulator 64 onto the surface of the wafer W, the drying of the wafer W is accelerated to increase the expansion speed of the dry region D toward the periphery of the wafer W. This may result in an increase in the moving speed of the cleaning solution nozzle 60. Thus, effective cleaning can be performed in a short time. In addition, since the speed of rotation of the wafer W is controlled such that the centrifugal force at each position of the feed of the cleaning solution R becomes constant in computation to uniformalize an amount of fed cleaning solution R per unit area of the surface of the wafer W, a great cleaning effect can be achieved even in the periphery of the wafer W.

### Second Embodiment

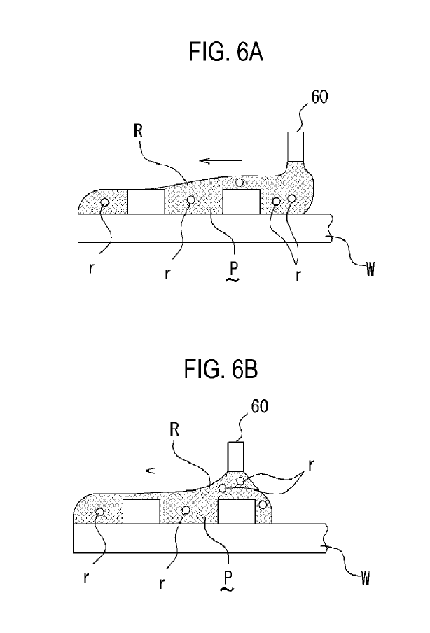

Next, a second embodiment of the substrate cleaning apparatus and method of the present disclosure will be described with reference to FIGS. 7A to 7D. The second embodiment uses the same substrate cleaning apparatus as the first embodiment and, therefore, an explanation of which will not be repeated. Hereinafter, a cleaning process of the second embodiment will be described.

This embodiment is similar to the first embodiment in terms of Steps 1 and 2. First, as shown in FIG. 7A, the cleaning solution R is fed from the cleaning solution nozzle 60 onto the center of the wafer W while rotating the wafer W. The temperature of the cleaning solution R at this time is set to a temperature higher than 23 degrees Celsius, for example, about 30 degrees Celsius, by means of the temperature regulator 64. Next, the cleaning solution nozzle 60 is moved by a predetermined distance toward the periphery of the wafer W and the gas nozzle 70 is arranged above the center of the wafer W. Then, gas is discharged from the gas nozzle 70 to form the dry region D (see FIG. 7B). Thereafter, the process proceeds to the following steps.

(Step 3α) While rotating the spin chuck 30 with the speed of rotation of more than 1500 rpm, for example, 2500 rpm, the cleaning solution nozzle 60 and the gas nozzle 70 are together moved some distance outward from the center C of the wafer W (see FIG. 7C) by moving the nozzle arm 66 (see FIG. 4). At this time, the cleaning solution nozzle 60 is moved at, for example, a speed of 10 mm/sec while discharging the cleaning solution R at a flow rate of, for example, 250 ml/min. At the same time, like the cleaning solution nozzle 60, the gas nozzle 70 is moved at a speed of, for example, 10 mm/sec while discharging N₂ gas. The cleaning solution nozzle 60 and the gas nozzle 70 are moved for 5 seconds, for example. Thus, the dry region D where the surface of the wafer W is completely dried is formed in a wider region in the outside of the center of the wafer W.

(Step 4α) Next, while rotating the spin chuck 30 with a smaller speed of rotation of, for example, 1100 rpm, like Step 3α, the cleaning solution nozzle 60 and the gas nozzle 70 are together moved toward the periphery of the wafer W (see FIG. 7C) by moving the nozzle arm 66. At this time, the moving speed of the cleaning speed of the cleaning solution nozzle 60 and the gas nozzle 70 is approximately equal to the expansion speed of the dry region D toward the periphery of the wafer W and is 10 mm/sec in this embodiment. Thus, since the temperature of the cleaning solution R is higher than 23 degrees Celsius which is the process atmosphere temperature, the expansion speed of the dry region D toward the periphery of the wafer W is high compared to conventional techniques, thereby increasing the moving speed of the nozzles 60 and 70 compared to the conventional techniques.

(Step 5α) When the position of the feed of the cleaning solution R reaches a position apart by 2 to 10 mm inward from the periphery of the wafer W, the feeds of the cleaning solution R and the N₂ gas from the cleaning solution nozzle 60 and the gas nozzle 70 are simultaneously stopped (see FIG. 7D).

In this embodiment, first, in Step 3α, by moving the cleaning solution nozzle 60 and the gas nozzle 70 toward the periphery of the wafer W while rotating the wafer W with the large speed of rotation and discharging the cleaning solution R and the N₂ gas G, the core of the dry region D formed in Step 2 is expanded to form a completely dried dry region D. Thus, a dissolved product existing at the center of the surface of the wafer W is removed up to the position of the feed of the cleaning solution R. With the subsequent movement of the cleaning solution nozzle 60, the dissolved product can be further effectively removed with it being taken on a liquid stream of the cleaning solution R.

In addition, in Step 4α, when the cleaning solution nozzle 60 and the gas nozzle 70 are together moved to the periphery of the wafer W while feeding the cleaning solution R from the cleaning solution nozzle 60, by continuously discharging the N₂ gas from the gas nozzle 70, a flow of air current on the wafer W is formed in the outside, thereby preventing mist from being again attached to the dry region D of the wafer W. Thus, concentric defects (see FIG. 11B) caused by reattachment of mist to the dry region D can be reduced.

### Third Embodiment

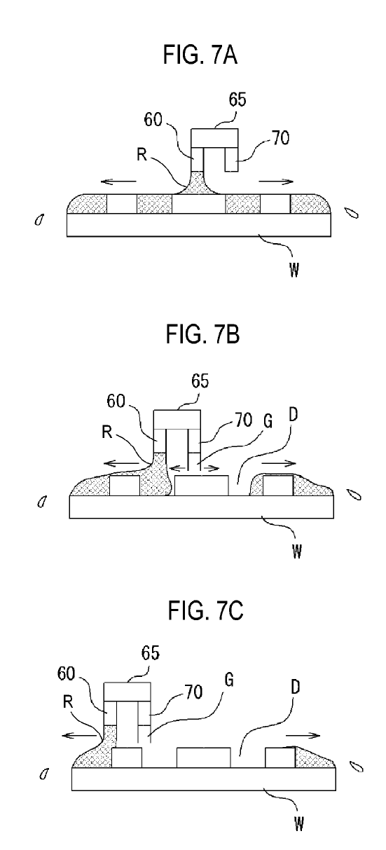

Next, a third embodiment of a substrate cleaning apparatus of the present disclosure will be described with reference to FIG. 8. As shown in FIG. 8, in a substrate cleaning apparatus 110 of this embodiment, a temperature regulator 54 equipped with a heating device, such as, for example, a heater or the like, is connected to a developer source 53 and adjusts the developer to a temperature, for example, about 30 degrees Celsius, higher than 23 degrees Celsius which is the process atmosphere temperature. This temperature is preferably more than 23 degrees Celsius and less than 50 degrees Celsius. A developer feeding pipe 51 including a flow rate regulator 52 is surrounded by a temperature maintaining member 51a such as an insulating member or the like. Thus, the developer can be maintained at a desired temperature controlled by the temperature regulator 54 until the developer is fed from a developer nozzle 50 onto the wafer W. Except the above configuration, this embodiment has the same configuration as the first embodiment and, therefore, an explanation of which will not be repeated with the same elements denoted by the same reference numerals.

A substrate cleaning method using the above-configured substrate cleaning apparatus 110 will be described in brief with reference to FIGS. 1 to 4 and FIG. 8.

First, before being carried into the substrate cleaning apparatus 110 of this embodiment, a wafer W subjected to liquid immersion lithography is taken out of the exposing section 4 by means of the second wafer carrying part 30B and is carried into the heating unit PEB constituting one stage of the shelf unit U6. After being heated in the heating unit PEB, the wafer W is carried from the heating unit PEB by means of the first wafer carrying part 30A and is carried into a temperature regulating unit of the shelf unit U3. The wafer W is adjusted to about 23 degrees Celsius to about 100 degrees Celsius in the temperature regulating unit. Thereafter, the wafer W is delivered to the spin chuck 30 of the substrate cleaning apparatus 110 of this embodiment by means of the main carrying means A3.

When the wafer W is delivered to the spin chuck 30, the outer cup 41 and the inner cup 42 are ascended and a developer is fed from the developer nozzle 50 onto the wafer W to form a circuit pattern. At this time, the temperature of the fed developer is about 30 degrees Celsius. Thus, the temperature of the wafer W is set to be higher than the process atmosphere temperature (23 degrees Celsius).

Next, the developer nozzle 50 is exchanged with the cleaning solution nozzle 60 which is arranged above the center of the wafer W and feeds the cleaning solution R. The subsequent cleaning process is performed as in the first embodiment.

At least during the feed of the cleaning solution R, the temperature of the cleaning solution R fed onto the surface of the wafer W may be equal to 23 degrees Celsius which is the process atmosphere temperature, or may be a temperature, for example, about 30 degrees Celsius, higher than 23 degrees Celsius. If the temperature of the cleaning solution R is equal to 23 degrees Celsius which is the process atmosphere temperature, since the temperature of the wafer W is adjusted to more than about 23 degrees Celsius and less than about 100 degrees Celsius, the cleaning solution R is heated when it is fed onto the surface of the wafer W, and thus, the temperature of the cleaning solution R on the surface of the wafer W becomes higher than 23 degrees Celsius which is the process atmosphere temperature. Accordingly, also in this case, the expansion speed of the dry region D toward the periphery of the wafer W is high compared to the case of the using the process atmosphere temperature, thereby increasing the moving speed of the cleaning solution nozzle 60 and hence improving a throughput as compared to conventional techniques.

In addition, in development, the wafer W and the developer are set to a high temperature to accelerate dissolution of a portion exposed to the developer, thereby shortening development time.

### Fourth Embodiment

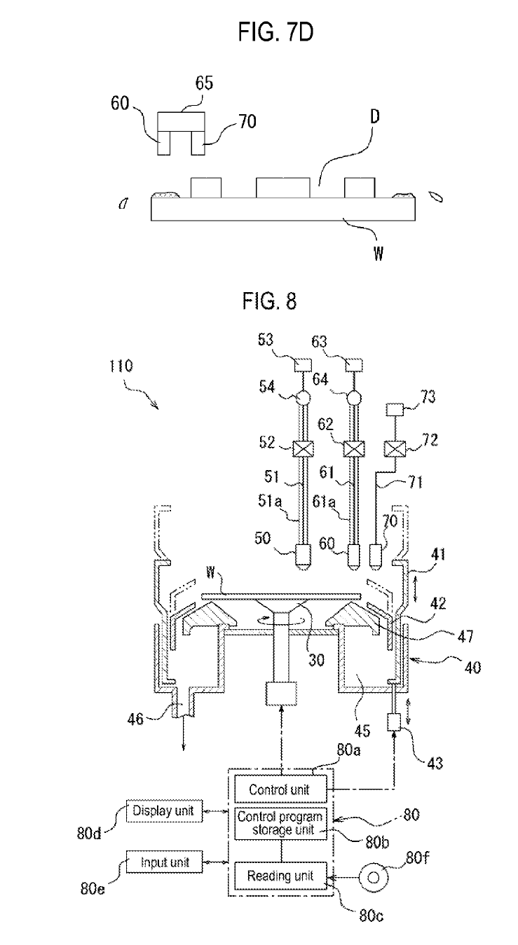

FIG. 9 is a longitudinal sectional view of a fourth embodiment of the substrate cleaning apparatus of the present disclosure.

This embodiment includes a back rinse nozzle 90 to remove a process solution such as a developer or the like provided at the periphery of the back side of the wafer W. The back rinse nozzle 90 is connected to the cleaning solution source 63 which is also connected to the cleaning solution nozzle 60, via the cleaning solution feeding pipe 61 with a flow rate regulator 62v, such as a suck back valve or the like, interposed therebetween. Like the first embodiment, a temperature regulator 64 equipped with a heating device, such as, for example, a heater or the like, is connected to a cleaning solution source 63 and adjusts the cleaning solution to a temperature, for example, approximately more than 23 degrees Celsius and less than 50 degrees Celsius, higher than 23 degrees Celsius which is the process atmosphere temperature. A cleaning solution feeding pipe 61 and the flow rate regulator 62v are surrounded by a temperature maintaining member 61b such as an insulating member or the like. Thus, the cleaning solution can be maintained at a desired temperature controlled by the temperature regulator 64 until the cleaning solution is fed from the back rinse nozzle 90 onto the periphery of the back side of the wafer W. Except for the back rinse nozzle 90, this embodiment has the same configuration as the first embodiment and, therefore, an explanation of which will not be repeated with the same elements denoted by the same reference numerals.

Next, a substrate cleaning method in the fourth embodiment will be described in brief. First, when the wafer W is delivered to the spin chuck 30, the outer cup 41 and the inner cup 42 are ascended. Then, the cleaning solution R adjusted to the temperature of, for example, more than 23 degrees Celsius and less than 50 degrees Celsius, is discharged from the back rinse nozzle 90 onto the periphery of the back side of the wafer W to heat from the back side of the wafer W. When the wafer W is heated to the temperature of, for example, more than 23 degrees Celsius and less than 50 degrees Celsius, the feed of the cleaning solution R from the back rinse nozzle 90 is stopped and the developer is fed from the developer nozzle 50 onto the wafer W to form a circuit pattern. At the time when the developer nozzle 50 is exchanged with the cleaning solution nozzle 60, the feed of the cleaning solution R from the back rinse nozzle 90 is restarted and the cleaning solution R set to the temperature higher than the process atmosphere temperature is simultaneously fed onto the front and back sides of the wafer W. The subsequent steps are the same as in the first embodiment and, therefore, an explanation of which will not be repeated.

In this embodiment, the wafer W is already heated before being cleaned by a hot back rinse. Thus, when the wafer W is cleaned after being developed, the heated cleaning solution R is not cooled when it is fed onto the surface of the wafer W. Accordingly, evaporation of the cleaning solution R on the surface of the wafer W is promoted to increase the expansion speed of the dry region D toward the periphery of the wafer W, thereby increasing the moving speed of the cleaning solution nozzle 60.

In addition, although in this embodiment the cleaning solution nozzle 60 and the back rinse nozzle 90 are connected to the cleaning solution source 63 in common, they may be separately connected to the cleaning solution source to control temperature individually. In this case, the temperature of the cleaning solution R fed from the cleaning solution nozzle 60 may be 23 degrees Celsius, which is the process atmosphere temperature. Even in this case, since the wafer W is beforehand heated by the back rinse, the cleaning solution R fed onto the surface of the wafer W is heated on the wafer W to increase the expansion speed of the dry region D toward the periphery of the wafer W.

### Fifth Embodiment

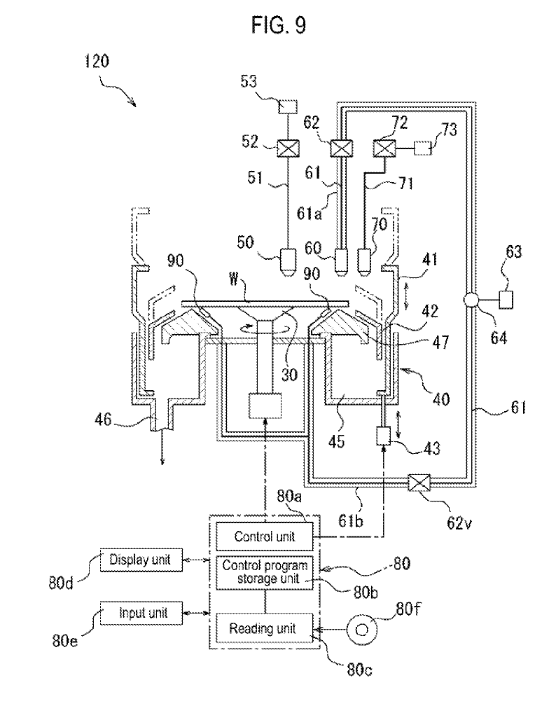

FIG. 10 is a longitudinal sectional view of a fifth embodiment of the substrate cleaning apparatus of the present disclosure.

A substrate cleaning apparatus 130 of the fifth embodiment has the same configuration as the fourth embodiment except that a gas nozzle 95 for discharging N₂ gas is arranged at a position of the back rinse nozzle 90 of the fourth embodiment and a temperature regulator 74 is provided in the gas feeding pipe 71, as shown in FIG. 10, and, therefore, an explanation of which will not be repeated with the same elements denoted by the same reference numerals.

In this embodiment, as shown in FIG. 10, the gas nozzle 95 to discharge the N₂ gas to the periphery of the back side of the wafer W is provided in the back side of the wafer W. The gas nozzle 95 is connected to the gas source 73 via the gas feeding pipe 71 with a flow rate regulator 72v interposed therebetween. The gas source 73 is also connected to the gas nozzle 70 for discharging N₂ gas onto the surface of the wafer W. In addition, the temperature regulator 74 equipped with a heating device, such as, for example, a heater or the like, is connected to the gas source 73 and adjusts the N₂ gas to a temperature, for example, about more than 23 degrees Celsius and less than 50 degrees Celsius. The gas feeding pipe 71 is surrounded by a temperature maintaining member 71b such as an insulating member or the like.

Next, a substrate cleaning method in the fifth embodiment will be described in brief. First, when the wafer W is delivered to the spin chuck 30, the outer cup 41 and the inner cup 42 are ascended. Then, the N₂ gas adjusted to the temperature of, for example, more than 23 degrees Celsius and less than 50 degrees Celsius, is discharged from the gas nozzle 95 onto the periphery of the back side of the wafer W to heat from the back side of the wafer W. When the wafer W is heated to the temperature of, for example, more than 23 degrees Celsius and less than 50 degrees Celsius, the developer is fed from the developer nozzle 50 onto the wafer W to form a circuit pattern. Meanwhile, the N₂ gas continues to be fed onto the back side of the wafer W. The developer nozzle 50 is exchanged with the cleaning solution nozzle 60 to feed the cleaning solution R onto the center of the surface of the wafer W. The subsequent steps are the same as the first embodiments and, therefore, an explanation of which will not be repeated.

In this embodiment, the back side of the wafer W is already heated before being cleaned by the hot N₂ gas. Thus, when the wafer W is cleaned after being developed, the heated cleaning solution R is not cooled when it is fed onto the surface of the wafer W. Accordingly, evaporation of the cleaning solution R on the surface of the wafer W is promoted to increase the expansion speed of the dry region D toward the periphery of the wafer W, thereby increasing the moving speed of the cleaning solution nozzle 60.

In addition, while the temperature of N₂ gas used to form a core of the dry region D is 23 degrees Celsius, which is equal to the process atmosphere temperature, in Step 2 of the first embodiment, in the fifth embodiment this temperature is equal to the temperature of the N₂ gas discharged to the back side of the wafer W, for example, more than 23 degrees Celsius and less than 50 degrees Celsius. Thus, the drying of the surface of the wafer W is further promoted to shorten cleaning time.

Although several embodiments have been described in the above, the present disclosure is not limited to the disclosed embodiments but may be modified in various ways without departing from the spirit and scope of the invention set forth in the annexed claims.

For example, although in the disclosed embodiments the heating unit, the back rinse or the N2 gas has been used to control the temperature of the wafer W, the wafer W may be heated using other methods before the feed of the cleaning solution R. For example, the wafer W may be heated before the feed of the cleaning solution R by irradiating the wafer W with LED light emitted from an LED light source arranged around the spin chuck 30 of the substrate cleaning apparatus immediately after the wafer W is loaded on the spin chuck 30. In this case, a plurality of LED light sources may be horizontally arranged in a radial shape, in a row or a cross (+) shape. The number of LED light sources may be properly determined depending on usage.

Although in the disclosed embodiments the cleaning solution nozzle 60 and the gas nozzle 70 were together fixed to the common nozzle arm 66, they may be fixed to their respective nozzle arms. In this case, since the gas nozzle 70 is arranged above the surface of the wafer W only when the N₂ gas is discharged, it is possible to prevent dew condensation due to mist or the like of the cleaning solution R from being attached to the gas nozzle 70. In addition, the cleaning solution nozzle 60 and the gas nozzle 70 may be disposed to be either vertical or inclined to the wafer W. In this case, the inclination direction of the cleaning solution nozzle 60 and the gas nozzle 70 is preferably equal to the rotation direction of the wafer W.

In addition, the evaporation of the cleaning solution R in the dry region D may be promoted by setting the humidity of the substrate cleaning apparatus of the present disclosure to be lower than those of other modules. In this case, the substrate cleaning method of the above embodiments may be performed with the humidity, which is typically set to about 45%, adjusted to about 40%.

In the disclosed embodiments, the speed of rotation of the wafer W is controlled such that the centrifugal force at each position of the feed of the cleaning solution R becomes constant in computation. However, from the standpoint of prevention of mist, it is preferable to control the speed of rotation of the wafer W such that a linear speed at each position of the feed of the cleaning solution R becomes constant in computation. As a ground for this, the present inventors have discovered by experiment that mist occurs as the difference between a linear speed of the wafer W at the position of the feed of the cleaning solution R and a discharging speed of the cleaning solution R increases. That is, as the difference between a linear speed of the wafer W and a discharging speed of the cleaning solution R increases, the cleaning solution R is more likely to bound when the cleaning solution R contacts the rotating wafer W, which results in a higher possibility of the occurrence of mist.

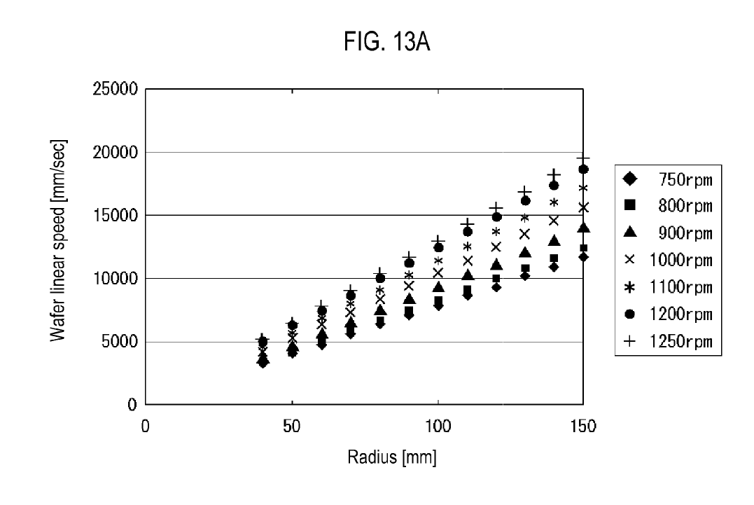

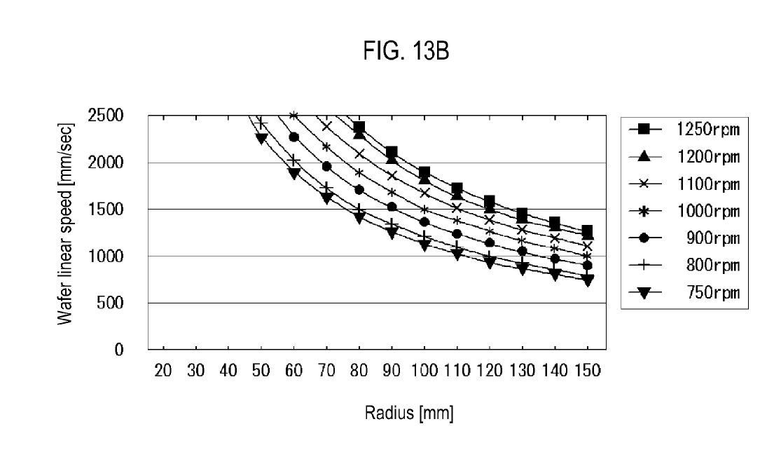

Referring to FIG. 11B showing the concentric defects caused by reattachment of mist, it can be seen that more mist is attached as it is closer to the periphery of the wafer W. FIG. 11B also shows a state of the wafer W cleaned when the cleaning solution is moved from the center toward periphery of the wafer W with the speed of rotation of the wafer W and a flow rate of discharged cleaning solution R kept constant. FIG. 13A is a graph showing a linear speed at each point on the wafer W for different speeds of rotation of the wafer W. As can be seen from FIG. 13A, the linear speed is considerably higher in the periphery of the wafer W than in the vicinity of the center of the wafer W. That is, when the flow rate of discharged cleaning solution R (discharging speed) and the speed of rotation of the wafer W are set to be constant, since the linear speed increases as it becomes closer to the periphery of the wafer W, a difference between the linear speed and the discharging speed of the cleaning solution R increases, which results a in higher possibility of the occurrence of mist. Accordingly, the occurrence of mist can be prevented by decreasing the speed of rotation of the wafer W such that the linear speed becomes constant in computation as a position of the feed of the cleaning solution R approaches the periphery of the wafer W.

In addition, as described above, it is preferable to set the speed of rotation as high as possible for improvement of throughput. In this case, as a method of setting the optimal speed of rotation, the speed of rotation at which no mist occurs in the periphery of the wafer W is first obtained, a linear speed at that time is calculated, and the speed of rotations at which linear speeds at different points becomes equal to each other may be obtained as the speed of rotation at each point. FIG. 13B shows the optimal speed of rotation at each point on the wafer W in a case where the speed of rotation when the position of the feed of the cleaning solution R is at the periphery of the wafer W is 1250 rpm, 1200 rpm, 1100 rpm, 1000 rpm, 900 rpm, 800 rpm and 750 rpm. For example, assuming that the maximum speed of rotation at which no mist occurs in the periphery of the wafer W is 1000 rpm, occurrence of mist at all points is prevented if the speed of rotation is controlled to be 2500 rpm at a position apart by 60 mm, 1500 rpm at a position apart by 100 mm, and 1000 rpm at a position (the periphery of the wafer W) apart by 150 mm from the center of the wafer W.

Although it has been here illustrated that the maximum speed of rotation at which no mist occurs in the periphery of the wafer W is 1000 rpm, by controlling the speed of rotation based on the graph shown in FIG. 13B, occurrence of mist at all points can be prevented even for speeds of rotation other than 1000 rpm at which no mist occurs.

In addition, the speed of rotation of the wafer W can be further increased by increasing the discharging speed of the cleaning solution R. A method of increasing the discharging speed of the cleaning solution R may include, for example, a method of increasing a flow rate of the cleaning solution R, a method of decreasing a diameter of the cleaning solution nozzle, etc.

The type of wafers used in the present disclosure is not limited to the wafer coated with a resist film and then formed with a circuit pattern by exposure and development but may be a wafer coated with a resist film before being exposed, a wafer subjected to liquid immersion lithography, or a wafer with a resist film peeled off after being etched. In addition, the present disclosure may be applied to not only a silicon wafer but also a glass substrate for flat panel display.

(1) According to the present disclosure, in some embodiments, by forming a liquid film on the entire surface of the substrate by feeding a cleaning solution onto the center of the substrate, forming a dry region by discharging gas to the center of the substrate while moving a position of the feed of the cleaning solution on the surface of the substrate by a predetermined distance from the center of the substrate toward the periphery of the substrate, and moving the position of the feed of the cleaning solution on the surface of the substrate toward the periphery of the substrate at a speed substantially equal to a speed at which the dry region is expanded toward the periphery of the substrate, it is possible to scrape out dissolved products left between circuit patterns of a resist film using the cleaning solution and discharge the dissolved products with them being taken out on a liquid stream of the cleaning solution. In addition, by setting the temperature of the cleaning solution to be higher than process atmosphere temperature on the surface of the substrate at least during the feed of the cleaning solution, the expansion speed of the dry region can be increased to shorten the substrate cleaning time and hence improve throughput.

(2) According to the present disclosure, in some embodiments, by moving the position of the feed of the cleaning solution and the position of the discharging of the gas together toward the periphery of the substrate, the drying of the dry region is promoted to effectively clean the substrate. In addition, since a flow of air current directed to the periphery of the substrate is formed at the position of the feed of the cleaning solution by the discharging of the gas, it is possible to prevent mist from being attached to the dry region.

(3) According to the present disclosure, in some embodiments, by decreasing the speed of rotation of the substrate as the position of the feed of the cleaning solution approaches the periphery of the substrate such that a linear speed at the position of the feed of the cleaning solution becomes constant in computation, it is possible to prevent the occurrence of mist. In addition, according to the present disclosure, in some embodiments, by making a centrifugal force at the position of the feed of the cleaning solution constant in computation, it is possible to uniformalize the amount of the feed of the cleaning solution onto the surface of the substrate and hence achieve a great cleaning effect for the periphery of the substrate.

### Example

Hereinafter, comparative experiments performed to complete the present disclosure will be described.

### Comparative Experiment 1

The substrate cleaning apparatus shown in FIG. 3 was used to perform an experiment of comparing dry states for a hydrophilic bare wafer of a 300 mm diameter. In this experiment, the substrate cleaning method of the first embodiment was performed with the temperature of a cleaning solution set to (A) process atmosphere temperature (23 degrees Celsius) (comparative example 1) and (B) 32.5 degrees Celsius (comparative example 2). The speed of rotation of the wafer in Step 1 was 1000 rpm, the cleaning solution was discharged to the center of the wafer for about 5 seconds at a flow rate of 250 ml/min, a cleaning solution nozzle was moved outward to discharge N₂ gas to the center of the wafer for about 5 seconds, scan rinse was performed, and the wafer was dried by rotation. In this comparative experiment, dry states were evaluated by checking the presence of residual water.

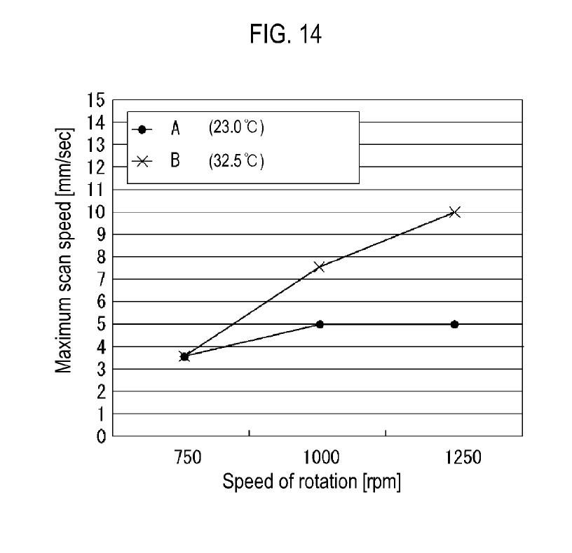

FIG. 14 is a graph showing a relationship between the speed of rotation of a wafer and the maximum value of a moving speed of a cleaning solution nozzle when a dry state of the wafer is good (no or little residual water). As shown in FIG. 14, when the speed of rotation was 1250 rpm, the maximum value of the moving speed of the cleaning solution nozzle to obtain a good dry state for (A) comparative example 1 was 5 mm/sec. Process time for (A) comparative example 1 was 43 seconds. On the other hand, when the temperature of the cleaning solution was set to 32.5 degrees Celsius as in (B) comparative example 2, a good dry state could be obtained even when the moving speed of the nozzle was set to 10 mm/sec with the same speed of rotation of 1250 rpm. Process time for (B) comparative example 2 was 32.5 seconds, which was shorter by 10.5 seconds than that of (A) comparative example 1.

In this comparative experiment, when the temperature of the cleaning solution was set to be higher than the process atmosphere temperature (23 degrees Celsius), it was shown that a good dry state was obtained even when the moving speed of the cleaning solution nozzle was set to be higher, as compared to a case where the temperature of the cleaning solution was set to the process atmosphere temperature (23 degrees Celsius). It is believed that this is because evaporation of the cleaning solution is promoted by the hot cleaning solution on the surface of the wafer, thereby increasing an expansion speed of a dry region toward the periphery of the wafer.

### Comparative Experiment 2

Using a 300 mm wafer having a circuit pattern of high hydrophobic resist formed thereon, the substrate cleaning apparatus shown in FIG. 3 was used to perform a comparative experiment with the substrate cleaning method of the first embodiment. Temperature of a cleaning solution was set to room temperature, for example, 23 degrees Celsius. In this comparative experiment, cleaning was performed while changing a moving speed of a cleaning solution nozzle for different speeds of rotation of the wafer, and a condition of the surface of the wafer after cleaning/drying was examined using a macro defect detector. Table 1 shows the evaluation results. In this table, NG1 represents a radial defect due to liquid scattering concomitant with a bad dry state (see FIG. 11A) and NG2 represents a concentric defect due to liquid bounding (see FIG. 11B).

TABLE 1

| Wafer rotation | Moving speed of nozzle (mm/sec) | | | |
|---|---|---|---|---|
| speed (rpm) | 3.5 | 5.0 | 7.5 | 10.0 |
| 750 | OK | NG1 | NG1 | NG1 |
| 1000 | OK | OK | NG1 | NG1 |
| 1250 | NG2 | NG2 | OK | NG1 |

### Comparative Experiment 3

Using a 300 mm wafer having a circuit pattern of high hydrophobic resist formed thereon, the substrate cleaning apparatus shown in FIG. 3 was used to perform a comparative experiment with the substrate cleaning method of the first embodiment. The temperature of a cleaning solution was set to 32.5 degrees Celsius as in comparative example 2 of Comparative Experiment 1. In this comparative experiment, cleaning was performed while changing a moving speed of a cleaning solution nozzle for different speeds of rotation of the wafer, and a condition of the surface of the wafer after cleaning/drying was examined using a macro defect detector. Table 2 shows the evaluation results.

TABLE 2

| Wafer rotation | Moving speed of nozzle (mm/sec) | | | |
|---|---|---|---|---|
| speed (rpm) | 3.5 | 5.0 | 7.5 | 10.0 |
| 750 | OK | NG1 | NG1 | NG1 |
| 1000 | NG2 | NG2 | OK | NG1 |
| 1250 | NG2 | NG2 | NG2 | OK |

Referring to FIG. 14 and Tables 1 and 2, from the results of Comparative Experiment 2 and Comparative Experiment 3 with the same speed of rotation of the wafer, it can be seen that, for both Comparative Experiment 2 and Comparative Experiment 3, the maximum nozzle moving speed for the good dry state in Comparative Experiment 1 substantially overlaps with the maximum nozzle moving speed for the case where results of the macro defect check of the wafer are not NG1 (radial defect due to liquid scattering). For this result, it is presumed that radial defect due to liquid scattering has a close relationship with a dry state of the wafer. That is, with the same speed of rotation of the wafer, when the nozzle moving speed is set to be substantially equal to the maximum moving speed when the dry state (the presence of residual water) of the wafer is good, that is, the expansion speed of the dry region toward the periphery of the wafer, it is believed that there occurs no radial defect due to liquid scattering. In addition, in comparison of Comparative Experiment 2 in which the temperature of the cleaning solution is the process atmosphere temperature of 23 degrees Celsius with Comparative Experiment 3 in which the temperature of the cleaning solution is higher than 23 degrees Celsius, with the same speed of rotation of the wafer, there occurs no radial defect due to liquid scattering even when the nozzle moving speed in Comparative Experiment 3 is higher. Accordingly, by setting the temperature of the cleaning solution to be higher than the process atmosphere temperature of 23 degrees Celsius, the nozzle moving speed can be increased to shorten the process time.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A method for cleaning a surface of a substrate having a circuit pattern formed thereon, comprising:
forming a liquid film on the entire surface of the substrate by feeding a cleaning solution onto the center of the surface of the substrate while rotating the substrate around the central axis of the substrate with the substrate kept horizontal;
forming a dry region by discharging gas to the center of the substrate while moving a position of feed of the cleaning solution on the surface of the substrate by a predetermined distance from the center of the substrate toward the periphery of the substrate with the substrate being rotated;
moving the position of feed of the cleaning solution on the surface of the substrate toward the periphery of the substrate at a speed substantially equal to a speed at which the dry region is expanded toward the periphery of the substrate while rotating the substrate; and
controlling a temperature of the cleaning solution to form the liquid film such that the temperature of the cleaning solution becomes higher than process atmosphere temperature on the surface of the substrate at least during feed of the cleaning solution.

2. The method of claim 1, wherein the temperature of the cleaning solution is more than 23 degrees Celsius, and less than or equal to 50 degrees Celsius.

3. The method of claim 1, wherein, in said moving the position of feed of the cleaning solution on the surface of the substrate, a speed of rotation of the substrate is 500 rpm to 3000 rpm.

4. The method of claim 1, wherein, in said moving the position of feed of the cleaning solution on the surface of the substrate, a moving speed of the position of feed of the cleaning solution is 5 mm/sec to 20.0 mm/sec.

5. The method of claim 1, wherein, in said forming a dry region, the position of feed of the cleaning solution and a position of discharging of the gas together are moved by a predetermined distance toward the periphery of the substrate, with the position of feed of the cleaning solution separated by a predetermined gap from the position of discharging of the gas and then the discharging of the gas is stopped.

6. The method of claim 1, wherein, in said moving the position of feed of the cleaning solution on the surface of the substrate, the position of feed of the cleaning solution and a position of discharging of the gas together toward the periphery of the substrate while feeding the cleaning solution and discharging the gas are moved, with the position of feed of the cleaning solution separated by a predetermined gap from the position of discharging of the gas, and then the feeding of the cleaning solution and the discharging of the gas are stopped when the position of feed of the cleaning solution reaches the periphery of the substrate.

7. The method of claim 1, wherein, in said moving the position of feed of the cleaning solution on the surface of the substrate, the speed of rotation of the substrate is decreased as the position of feed of the cleaning solution approaches the periphery of the substrate such that a linear speed at the position of feed of the cleaning solution becomes constant in computation.

8. The method of claim 1, wherein, in said moving the position of feed of the cleaning solution on the surface of the substrate, the speed of rotation of the substrate is decreased as the position of feed of the cleaning solution approaches the periphery of the substrate such that a centrifugal force at the position of feed of the cleaning solution becomes constant in computation.

9. The method of claim 1, wherein said controlling temperature of the cleaning solution is performed by controlling the temperature of the cleaning solution using a temperature regulator before the cleaning solution is fed onto the substrate.

10. The method of claim 1, wherein said controlling temperature of the cleaning solution is performed by feeding the cleaning solution onto the substrate having a temperature higher than 23 degrees Celsius.

11. The method of claim 10, wherein the substrate having a temperature higher than 23 degrees Celsius is temperature-controlled by being heated by a heater and then being developed by a developer having a temperature higher than 23 degrees Celsius.

12. The method of claim 10, wherein the substrate having a temperature higher than 23 degrees Celsius is temperature-controlled by discharging a rinse solution having a temperature higher than 23 degrees Celsius to the back side of the substrate.

13. The method of claim 10, wherein the substrate having a temperature higher than 23 degrees Celsius is temperature-controlled by discharging gas having a temperature higher than 23 degrees Celsius to the back side of the substrate.

14. An apparatus for cleaning a surface of a substrate having a circuit pattern formed thereon, comprising:
a substrate holder which holds the substrate horizontally such that the center of the substrate coincides with the central axis of rotation of the substrate;
a rotation mechanism which rotates the substrate holder around the rotation central axis;
a cleaning solution nozzle which feeds a cleaning solution onto the surface of the substrate held by the substrate holder;
a gas nozzle which discharges gas to the surface of the substrate held by the substrate holder;
a nozzle driving mechanism which moves the cleaning solution nozzle and the gas nozzle, respectively;
a temperature regulator which controls a temperature of the cleaning solution such that the temperature of the cleaning solution becomes higher than process atmosphere temperature on the surface of the substrate; and
a controller which controls the rotation mechanism, a feeding part of the cleaning solution nozzle, a feeding part of the gas nozzle, the nozzle driving mechanism and the temperature regulator,
wherein, based on a control signal from the controller, a liquid film is formed on the entire surface of the substrate by feeding the cleaning solution from the cleaning solution nozzle onto the center of the surface of the substrate while rotating the substrate, a dry region is formed by discharging gas from the gas nozzle to the center of the substrate while moving the cleaning solution nozzle by a predetermined distance from above the center of the substrate toward the periphery of the substrate, and the cleaning solution nozzle is moved toward the periphery of the substrate at a speed substantially equal to a speed at which the dry region is expanded toward the periphery of the substrate.

15. The apparatus of claim 14, wherein the temperature regulator is disposed on a pipe path connected between the cleaning solution nozzle and a source of cleaning solution and is configured to set the temperature of the cleaning solution to be more than 23 degrees Celsius, and less than or equal to 50 degrees Celsius.

16. The apparatus of claim 14, wherein a back rinse nozzle, which discharges a cleaning solution having temperature higher than 23 degrees Celsius to the periphery of the back side of the substrate, is arranged on the back side of the substrate.

17. The apparatus of claim 14, wherein a gas nozzle, which discharges gas having a temperature higher than 23 degrees Celsius to the periphery of the back side of the substrate, is arranged on the back side of the substrate.

18. An apparatus for cleaning a surface of a substrate having a circuit pattern formed thereon, comprising:
a substrate holder which holds the substrate horizontally such that the center of the substrate coincides with the central axis of rotation of the substrate;
a rotation mechanism which rotates the substrate holder around the rotation central axis;
a cleaning solution nozzle which feeds a cleaning solution onto the surface of the substrate held by the substrate holder;
a gas nozzle which discharges gas to the surface of the substrate held by the substrate holder;
a nozzle driving mechanism which moves the cleaning solution nozzle and the gas nozzle together with the cleaning solution nozzle separated by a predetermined gap from the gas nozzle;
a temperature regulator which controls a temperature of the cleaning solution such that the temperature of the cleaning solution becomes higher than process atmosphere temperature on the surface of the substrate; and
a controller which controls the rotation mechanism, a feeding part of the cleaning solution nozzle, a feeding part of the gas nozzle, the nozzle driving mechanism and the temperature regulator,
wherein, based on a control signal from the controller, a liquid film is formed on the entire surface of the substrate by feeding the cleaning solution from the cleaning solution nozzle onto the center of the surface of the substrate while rotating the substrate, a dry region is formed by arranging the gas nozzle above the center of the substrate and discharging gas from the gas nozzle to the center of the substrate while moving the cleaning solution nozzle from above the center of the substrate toward the periphery of the substrate, the cleaning solution nozzle and the gas nozzle are moved together toward the periphery of the substrate at a speed substantially equal to a speed at which the dry region is expanded toward the periphery of the substrate, and the feeding of the cleaning solution and the discharging of the gas are stopped when the cleaning solution nozzle reaches above the periphery of the substrate.

19. The apparatus of claim 18, wherein the temperature regulator is disposed on a pipe path connected between the cleaning solution nozzle and a source of cleaning solution and is configured to set the temperature of the cleaning solution to be more than 23 degrees Celsius, and less than or equal to 50 degrees Celsius.

20. The apparatus of claim 18, wherein a back rinse nozzle, which discharges a cleaning solution having a temperature higher than 23 degrees Celsius to the periphery of the back side of the substrate, is arranged on the back side of the substrate.

21. The apparatus of claim 18, wherein a gas nozzle, which discharges gas having a temperature higher than 23 degrees Celsius to the periphery of the back side of the substrate, is arranged on the back side of the substrate.

22. A computer readable storage medium for use with an apparatus for cleaning a surface of a substrate having a circuit pattern formed thereon, the medium recorded with software to cause a computer to execute a control program to perform the substrate cleaning method of claim 1.
